(19) United States
(12) Patent Application Publication
(10) Pub. No.: US 2019/0057330 A1
(43) Pub. Date: Feb. 21, 2019

(54) DIGITAL METHOD FOR FACILITATING THE ORGANISATION OF AN EVENT OR PROJECT

(71) Applicant: Openstageit Ltd, London (GB)

(72) Inventor: Samuel Richard Barlow, London (GB)

(21) Appl. No.: 16/113,038

(22) Filed: Aug. 27, 2018

Related U.S. Application Data
(63) Continuation-in-part of application No. 15/678,364, filed on Aug. 16, 2017.
(60) Provisional application No. 62/375,585, filed on Aug. 16, 2016.

(51) Int. Cl. G06Q 10/02; G06Q 30/02

(52) U.S. Cl. CPC G06Q 10/02; G06Q 30/0252; G06Q 30/0279; G06Q 30/0205

(57) ABSTRACT

A facilitation method for organizing an event or project consisting of the following steps:
making a proposal of an event or project, the proposal:
   setting out choices for the event or project and
   enabling respondents to indicate preferences amongst the choices;
allocation of an account for receipt of money from respondents upon triggering the event or project, the proposal:
   further enabling respondents to provide commitment to pay to attend or participate in the proposed event or project;
electronic advertisement of the event or project;
receiving preferences and commitments to pay from respondents; and
determination of whether the received preferences and commitments to pay are sufficient to warrant the event or project being triggered.

The present invention is a continuation-in-part of U.S. patent application Ser. No. 15/678,364 filed Aug. 16, 2017, which claims the benefit of U.S. provisional application Ser. No 62/375,585 filed Aug. 16, 2016.

The present invention relates to a facilitation method for individuals to indicate their interest in a proposed event or project in a geographic area via a data processor.

It is known that interest in a potential event can be given through social media, for instance Facebook®. An event can be created and users may then click “attending”, “maybe” or “not attending”. The information gathered can be misleading as people do not necessarily intend to attend an event they have responded to.

U.S. patent application Ser. No 15/678.364 filed Aug. 16, 2017 there is claimed a facilitation method whereby a proposer proposes bringing an event or project to a geographic area, members of the public may then indicate their interest in the proposed event or project in that geographical area, in the instance that one or more respondents cumulatively indicate their interest in an event or project with an exchange of assets via a data processor the event or project may occur, the method comprising the following steps:
proposal by a proposer of an event or project in a geographic area by a proposer;
selection by the proposer of geographic choice parameters for the respondents;
allocation of an account for receipt of money from respondents upon triggering the event or project;
electronic advertisement of the event;
indication of interest by respondents for the proposed event or project at a geographic position with the geographic position being within the geographic area, together with indication of the respondent's payment details for taking of payment by the proposer into a proposer's account;
determination by the proposer of whether the indicated interest is sufficient to warrant the event being triggered;
triggering of the event.

An object of the present invention is to provide an improved facilitation method, in particular without restriction to geographic choice parameters.

Accordingly the invention provides a facilitation method for a proposer to propose an event or project with a subject to the public and enable them to indicate preferences amongst choices for it and financial intent to attend or participate, the method consisting in steps by the proposer of:
making a proposal of an event or project, the proposal:
   setting out choices for the event or project and
   enabling respondents to indicate preferences amongst the choices;
allocation of an account for receipt of money from respondents upon triggering the event or project, the proposal:
   further enabling respondents to provide commitment to pay to attend or participate in the proposed event or project;
electronic advertisement of the event or project;
receiving preferences and commitments to pay from respondents; and
determination of whether the received preferences and commitments to pay are sufficient to warrant the event or project being triggered.

The subject of the event or project can be in diverse fields:
entertainment, music in particular
travel
academia
professional
commercial
etc.

The choices can be within the subject or unrelated to the subject. In other words, the choices can be subsets of the subject.

Examples of related choices, including sub-choices, are, for instance:
subject: history
   choice: medieval or modern
subject: music
   choice: classical or pop
      sub-choice: artist A, artist B, artist C
etc.

Examples of unrelated choices are:
main choice: nearest town
   sub-choices: 5, 10 or 15 mile radius of the town
main choice: Venue A, Venue B, Venue C, all in certain City
main choice: 1 day duration, 2 day duration
main choice: month
   sub-choice: day of week in month
      sub-sub-choice: time of day
etc.

Commitment to pay options can be for more or less expensive options and for one or more respondents.

Another object of the present invention is to provide an improved facilitation method, in particular without restriction to respondents committing to pay to attend or participate in the proposed event or project.

Accordingly another aspect of the invention also provides a facilitation method for a proposer to propose an event or project with a subject to the public and enable them to indicate preferences amongst choices for it, the method consisting in steps by the proposer of:
making a proposal of an event or project, the proposal:
   setting out choices for the event or project and
   enabling respondents to indicate preferences amongst the choices;
electronic advertisement of the event or project;
receiving preferences from respondents; and
determination of whether the received preferences are sufficient to warrant the event or project being triggered.

A further object of the present invention is to provide an improved facilitation method, in particular enabling respondents preferences to be refined with information from other data sets.

Accordingly to a further aspect of the invention further provides a facilitation method for a proposer to propose an event or project with a subject to the public and enable them to indicate preferences amongst choices for it, the method consisting in steps by the proposer of:
making a proposal of an event or project, the proposal:
   setting out choices for the event or project and
   enabling respondents to indicate preferences amongst the choices;
electronic advertisement of the event or project;
receiving preferences from respondents;
combining the received preferences with known data to provide a refined prediction of intention to attend or participate in the proposed event or project and
determination of whether the refined prediction of intention is sufficient to warrant the event or project being triggered.

The data sets can be as diverse as the subject of the event or project and the choices for it. Normally they will take the form of publicly available data, which can be predicted to bias the predicted intention. For instance in a region where the population is predominant older and therefore respondent can be expected to give firmer intentions, the indication of intention can be regarded as predictable; whereas in a region where the population is predominantly younger, the indication of intention can be regarded as less predictable, but leavened with an expectation that last minute decisions will result in an attendance higher than indicated prima facie.

A fourth object of the present invention is to provide an improved facilitation method, in particular enabling members of the public to suggest a modified event or project for a proposer to adopt.

Accordingly to a fourth aspect of the invention also provides a facilitation method for a proposer to propose an event or project with a subject to the public and enable them to indicate preferences amongst choices for it, the method consisting in steps by the proposer of:
making a proposal of an event or project, the proposal:
   setting out choices for the event or project and
   enabling respondents to indicate preferences amongst the choices;
electronic advertisement of the event or project;
enabling a potential respondent to modify the choices for the proposal and to request electronic advertisement of the proposal;
receiving preferences from respondents to the modified proposal; and
determination of whether the received preferences are sufficient to warrant the modified proposal project being triggered.

It is envisaged that the subject of the modified event may change, although this is unlikely as the subject is a broad categorisation. Nevertheless overlap is possible for instance an event in the entertainment field could be modified to be an event in the travel field. Normally the event is expected to be modified as regards the choices set. For instance an event thought at first to be feasible only by one mode of travel may due to knowledge not available to the proposer to be feasible, and may be more attractive, by another mode of travel.

A fifth object of the present invention is to provide an improved facilitation method, in particular enabling one or more members of the public instrumental in causing received preferences reaching a triggering level to be rewarded.

Accordingly the fifth aspect of the invention also provides a facilitation method for a proposer to propose an event or project with a subject to the public and enable them to indicate preferences amongst choices for it, the method consisting in steps by the proposer of:
making a proposal of an event or project, the proposal:
   setting out choices for the event or project and
   enabling individual respondents to indicate
      preferences amongst the choices and
      identity of a reward-worth member of the public by whom awareness the event or project was brought to attention of the responding respondent;
electronic advertisement of the event or project;
receiving preferences from respondents;
determination of whether the received preferences are sufficient to warrant the event or project being triggered and
rewarding the reward worthy member of the public.

The reward make take one of a number of forms, such as an introduction to a significant participant in an event, such as an artist in a concert or a professor in an academic conference. Alternatively the reward can be in physical form such as memento of the event or project.

Particularly where the proposal is for something altruistic, such as a proposal for a charitable event, where the respondents' commitments are to pay charitable donations, the reward can be an altruistic reward such as participation in the charitable work.

A sixth object of the present invention is to provide an improved facilitation method, in particular enabling responding members of the public to be put in touch with each other so that they can discuss the proposed event or project.

Accordingly the sixth aspect of the invention also provides a facilitation method for a proposer to propose an event or project with a subject to the public and enable them to indicate preferences amongst choices for it, the method consisting in steps by the proposer of:
making a proposal of an event or project, the proposal:
   setting out choices for the event or project and
   enabling individual respondents to indicate
      preferences amongst the choices and
      a telecommunication address or number;
electronic advertisement of the event or project;
receiving preferences from respondents;
distributing to respondents the telecommunication address or number of other respondents and
determination of whether the received preferences are sufficient to warrant the event or project being triggered.

Whilst the telecommunication address or number of all previous respondents can be distributed to all previous respondents, it is expected that this will result in an unmanageable quantity of such data being distributed. It is preferable to select the respondent into groups to be put in communication with each other. The groups can be defined in terms of when they responded, for instance all those responding on one day being put in contact with each other and those for the next day likewise. Alternatively they can be grouped by batches responding, the next group being started after the previous group has reached a specific size. Again respondents can be grouped by their geographical location or by their age group, where this is asked for.

Further grouping may be provided for, such as by communication activity. For this, the method provides for routing of the communications via a link from a site providing the advertisement of the proposal and the ability to respond.

Again, particularly with a view to rewarding active communicators about the event or project, more active communicators can be put in contact with other more active communicators in addition to their group.

In particular with a view to a reward for promoting the project of event, respondents are provided with means for providing the communication details of other potential responders to whom the proposal can be advertised, with reward status being augmented by subsequent response by those to whom the event was advertised in this way.

To help understanding of the invention, a specific embodiment thereof will now be described by way of example and with reference to the accompanying drawings, in which:

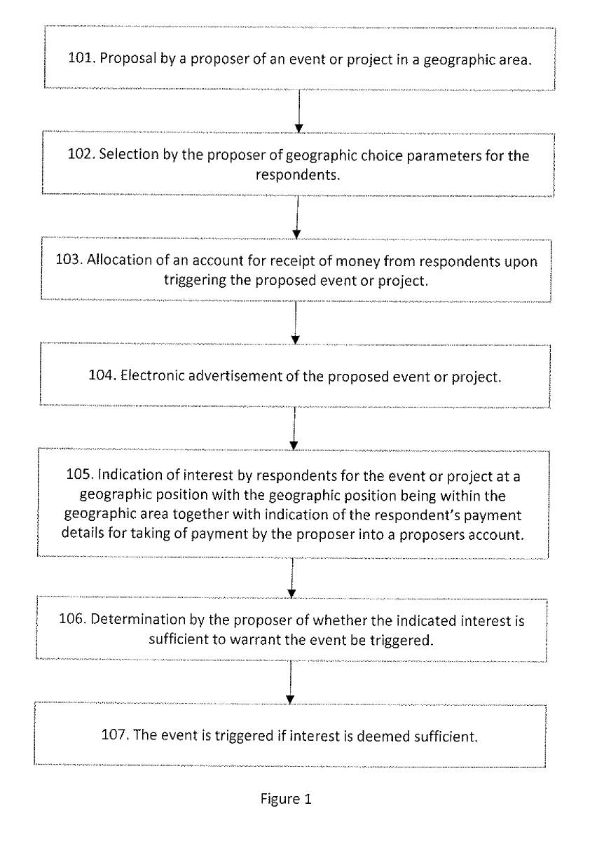

FIG. 1 is a flowchart diagram of how the facilitation method for organizing an event or project is executed in accordance with the first embodiment of the invention;

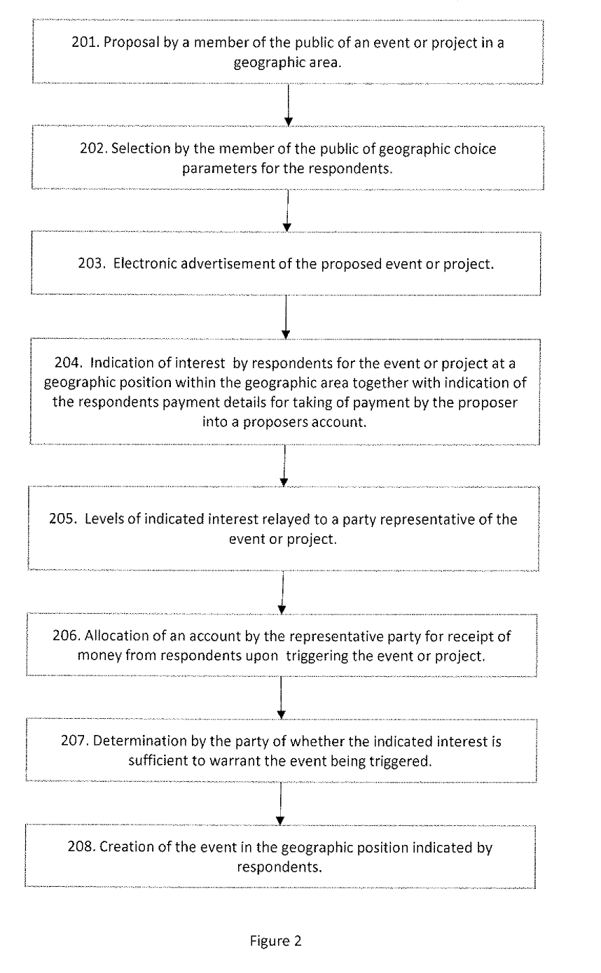

FIG. 2 is a flowchart diagram of how the facilitation method for organizing an event or project is executed in accordance with the second embodiment of the invention;

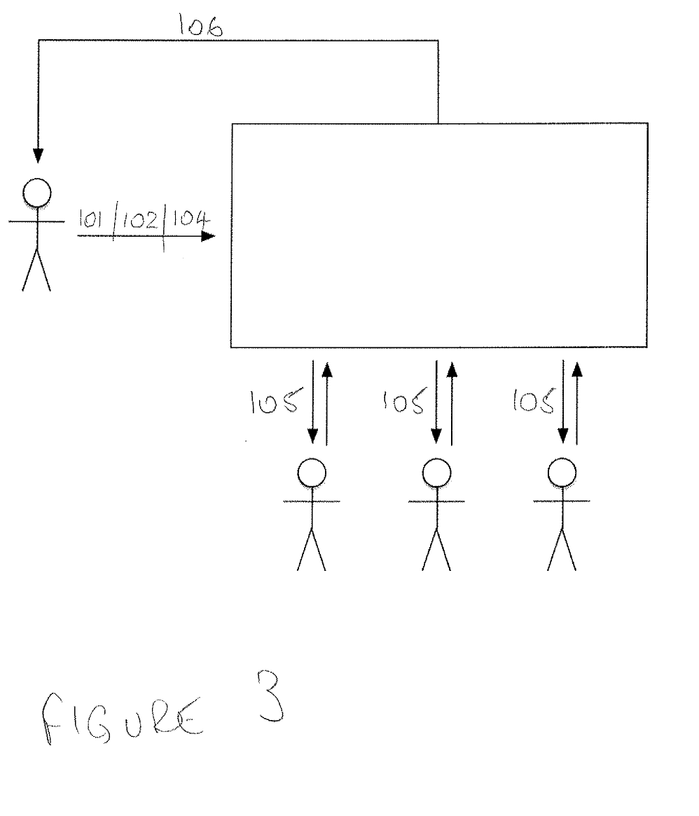

FIG. 3 is a diagram representative of how the event organization method performs in accordance with the present invention;

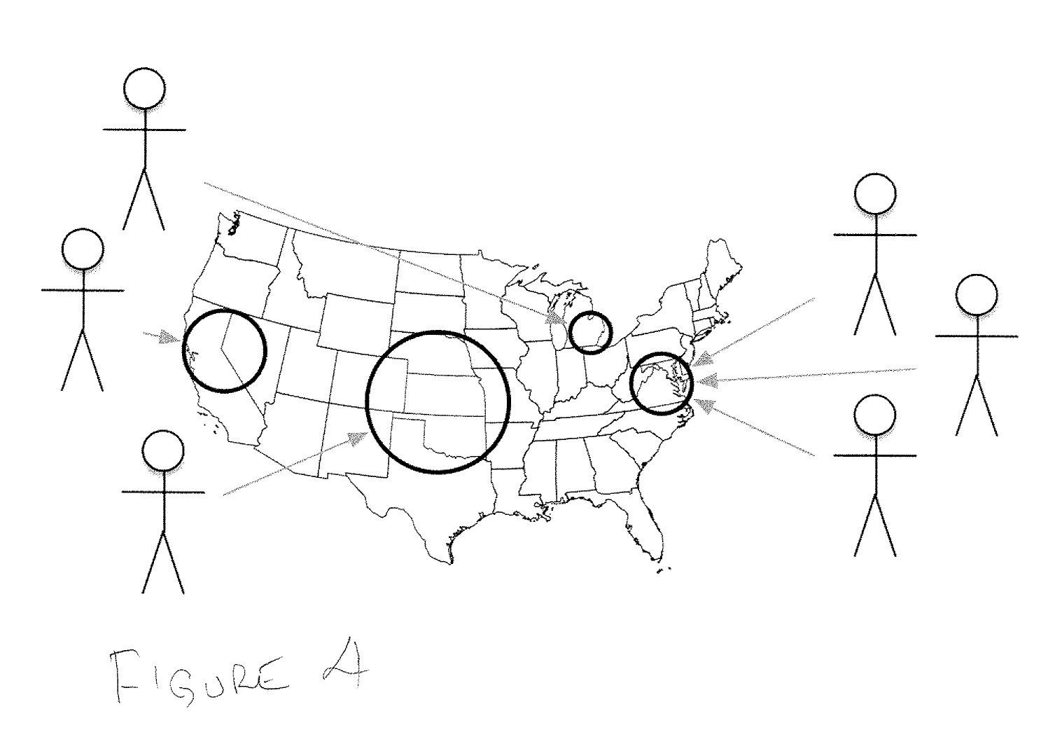

FIG. 4 is a diagram depicting how respondents may indicate interest in an event or project in different geographic areas.

Referring to FIG. 1, the flowchart in accordance with the first embodiment of the invention, event or project organization may be enhanced by the following method steps:
101. Proposal by a proposer of an event or project in a geographic area;
102. Selection by the proposer of geographic choice parameters for the respondents;
103. Allocation of an account for receipt of money from respondents upon triggering the proposed event or project;
104. Electronic advertisement of the proposed event or project;
105. Indication of interest by respondents for the event or project at a geographic position with the geographic position being within the geographic area together with indication of the respondent's payment details for taking of payment by the proposer into a proposers account;
106. Determination by the proposer of whether the indicated interest is sufficient to warrant the event being triggered;
107. The event is triggered if interest is deemed sufficient.

The invention is not intended to be restricted to the details of the above described embodiment. For instance, it is possible that the party does not propose the event, but instead a member of the public does, as in the second embodiment. It is also possible that the accounts are created by the respondents for use within the method, these accounts could be pre-existing accounts such as PayPal® or Facebook® accounts.

Referring to FIG. 2, the flowchart in accordance with the second embodiment of the invention, event or project organization may be enhanced by the following method steps:
201. Proposal by a member of the public of an event or project in a geographic area;
202. Selection by the member of the public of geographic choice parameters for the respondents;
203. Electronic advertisement of the proposed event or project;
204. Indication of interest by respondents for the event or project at a geographic position within the geographic area together with indication of the respondents payment details for taking of payment by the proposer into a proposers account;
205. Levels of indicated interest relayed to a party representative of the event or project;
206. Allocation of an account by the representative party for receipt of money from respondents upon triggering the event or project;
207. Determination by the party of whether the indicated interest is sufficient to warrant the event being triggered;
208. Creation of the event in the geographic position indicated by respondents;

Referring to FIG. 3, the diagram representative of how the present invention is used by both respondents and the proposer. In order for the method to be executed there must be a party with the capability of electronically advertising the event or project. Once an event or project has been proposed and advertised, potential respondents are able to see it. Respondents then indicate their interest in a proposed event or project. The data regarding indicated interest, and the amount pledged is made available to the organizing party, if the organizing party is a member of the public, it is assumed that the information would be made available to the appropriate representative. If demand is sufficient and the party or appropriate representative decides to proceed with the event, then the event is triggered. Respondents who pledged for the event may then obtain tickets.

Referring to FIG. 4, the diagram depicting how respondents may indicate interest in an event or project in different geographic areas. It can be seen that respondents are able to indicate their interest in different proposed events or projects. These have been depicted by the dotted lines. The proposed event in London has clearly garnered more interest than the events in Plymouth or Cardiff. The proposer can then use this information in order to determine whether the event should be triggered. If triggered the respondents who registered interest may exchange their pledge for a ticket.

The above embodiments are on the basis that the event or project, a concert or a seminar for instance, are proposed to be in a certain are geographic area. However, where for instance the public are able to participate on line, either actively interactively or passively, a geographic limitation on the proposal is of no consequence. However it is within the invention that such an event such as a live broadcast, receivable on payment of a fee, of an opera or concert should be proposed. The choices could be between different performances on different dates. The method allows the public to indicate which operas they wish to view and for the proposer to know which it is economic to broadcast in this way.

Again academic and professional lectures can be proposed, chosen and determined in the same way.

In the travel field, cruises by sea and railway excursions could be proposed in the same way, for instance as regards choices between cities visited and the order of visiting.

In all these examples, there can be main choices such as:
In the field of opera when a company is planning its season of performances, a main choice between composers and subsidiary choices between actual operas;
In the field of the arts, when a company is planning accompanied tours, the main choice could be between painters, sculptors & architects and the subsidiary sub-choices between the actual works of art;
In the field of academia, when a summer school is planning its curriculum, the main choices could be between ancient, post classical, mediaeval and modem history and the sub-choices between Greek, Italian, French, German and English histories for instance.

The commitments can include media of participation, such as physical attendance, receipt of audio-visual streaming or merely audio streaming.

The event of project may be one in which a commitment to pay is not appropriate, such as a proposed event in which volunteers clear up eye-sores and in which the choices relate to what eye-sore is in most need of clearing up and when.

The received preferences may be advantageously combined with known data. For instance, expressions of interest in classical music as a part of an excursion as opposed to modern music is likely to indicate a predominance of older respondents. In turn, if the respondents have indicated from their banking details a predominance from non-English speaking countries, there is more likelihood of the need to provide multi-lingual tour guides. Algorithms for such predictions are straightforward and require no elaboration.

It is anticipated that an originally proposed event or project may be recognised by respondents as susceptible of improvement. To allow for this, respondents may be enabled to propose modified events.

The respondents may be encouraged to identify the person from whom they heard of the event or project. This can result in the person causing most dissemination of news of the event to be rewarded.

The respondent may also be encouraged to give a telecommunication number or address, whereby they can participate in a chat group and spread the word about the project or event.

1. A facilitation method for a proposer to propose an event or project with a subject to the public and enable them to indicate preferences amongst choices for it and financial intent to attend or participate, the method consisting in steps by the proposer of:
making a proposal of an event or project, the proposal:
setting out choices for the event or project and
enabling respondents to indicate preferences amongst the choices;
allocation of an account for receipt of money from respondents upon triggering the event or project, the proposal:
further enabling respondents to provide commitment to pay to attend or participate in the proposed event or project;
electronic advertisement of the event or project;
receiving preferences and commitments to pay from respondents; and
determination of whether the received preferences and commitments to pay are sufficient to warrant the event or project being triggered.

2. A facilitation method according to claim 1, wherein the subject of the event or project is selected from the set consisting of:
entertainment, music in particular, events and projects
travel events and projects
academia events and projects
professional events and projects and
commercial events and projects.

3. A facilitation method according to claim 1, wherein the choices are a subset of the subject of the event or project.

4. A facilitation method according to claim 1, wherein the choices are unrelated to the subject of the event or project.

5. A facilitation method according to claim 1, wherein the choices include at least one level of subsidiary choices.

6. A facilitation method according to claim 1, wherein the commitments to pay include options.

7. A facilitation method for a proposer to propose an event or project with a subject to the public and enable them to indicate preferences amongst choices for it, the method consisting in steps by the proposer of:
making a proposal of an event or project, the proposal:
setting out choices for the event or project and
enabling respondents to indicate preferences amongst the choices;
electronic advertisement of the event or project;
receiving preferences from respondents; and
determination of whether the received preferences are sufficient to warrant the event or project being triggered.

8. A facilitation method according to claim 7, wherein the subject of the event or project is selected from the set consisting of:
entertainment, music in particular, events and projects
travel events and projects
academia events and projects
professional events and projects and
commercial events and projects.

9. A facilitation method according to claim 7, wherein the choices are a subset of the subject of the event or project.

10. A facilitation method according to claim 7, wherein the choices are unrelated to the subject of the event or project.

11. A facilitation method according to claim 7, wherein the choices include at least one level of subsidiary choices.

12. A facilitation method for a proposer to propose an event or project with a subject to the public and enable them to indicate preferences amongst choices for it, the method consisting in steps by the proposer of:
making a proposal of an event or project, the proposal:
setting out choices for the event or project and
enabling respondents to indicate preferences amongst the choices;
electronic advertisement of the event or project;
receiving preferences from respondents;
combining the received preferences with known data to provide a refined prediction of intention to attend or participate in the proposed event or project and
determination of whether the refined prediction of intention is sufficient o warrant the event or project being triggered.

13. A facilitation method according to claim 12, the method including the steps of:
allocation of an account for receipt of money from respondents upon triggering the event or project, the proposal:
further enabling respondents to provide commitment to pay to attend or participate in the proposed event or project; and
receiving commitments to pay from respondents.

14. A facilitation method according to claim 13, wherein the commitments to pay include options.

15. A facilitation method according to claim 12, wherein the choices are a subset of the subject of the event or project.

16. A facilitation method according to claim 12, wherein the choices are unrelated to the subject of the event or project.

17. A facilitation method according to claim 12, wherein the choices include at least one level of subsidiary choices.

18. A facilitation method for a proposer to propose an event or project with a subject to the public and enable them to indicate preferences amongst choices for it, the method consisting in steps by the proposer of:
making a proposal of an event or project, the proposal:
setting out choices for the event or project and
enabling respondents to indicate preferences amongst the choices;
electronic advertisement of the event or project;
enabling a potential respondent to modify the choices for the proposal and to request electronic advertisement of the proposal;
receiving preferences from respondents to the modified proposal; and
determination of whether the received preferences are sufficient to warrant the modified proposal project being triggered.

19. A facilitation method according to claim 18, wherein provision is made for modification of the subject of the event or project and/or choices therefor.

20. A facilitation method according to claim 18, the method including the steps of:
allocation of an account for receipt of money from respondents upon triggering the event or project, the proposal:
further enabling respondents to provide commitment to pay to attend or participate in the proposed event or project; and
receiving commitments to pay from respondents.

21. A facilitation method according to claim 20, wherein the commitments to pay include options.

22. A facilitation method according to claim 18, wherein the choices are a subset of the subject of the event or project.

23. A facilitation method according to claim 18, wherein the choices are unrelated to the subject of the event or project.

24. A facilitation method according to claim 18, wherein the choices include at least one level of subsidiary choices.

25. A facilitation method for a proposer to propose an event or project with a subject to the public and enable them to indicate preferences amongst choices for it, the method consisting in steps by the proposer of:
making a proposal of an event or project, the proposal:
setting out choices for the event or project and
enabling individual respondents to indicate
preferences amongst the choices and
identity of a reward-worth member of the public by whom awareness the event or project was brought to attention of the responding respondent;
electronic advertisement of the event or project;
receiving preferences from respondents;
determination of whether the received preferences are sufficient to warrant the event or project being triggered and
rewarding the reward worthy member of the public.

26. A facilitation method according to claim 25, wherein the reward is selected from the set consisting of:
an introduction to a significant participant in the event or project,
a momento thereof,
participation in charitable work.

27. A facilitation method according to claim 25, wherein the commitments to pay include options.

28. A facilitation method according to claim 25, wherein the choices are a subset of the subject of the event or project.

29. A facilitation method according to claim 25, wherein the choices are unrelated to the subject of the event or project.

30. A facilitation method according to claim 25, wherein the choices include at least one level of subsidiary choices.

31. A facilitation method for a proposer to propose an event or project with a subject to the public and enable them to indicate preferences amongst choices for it, the method consisting in steps by the proposer of:
making a proposal of an event or project, the proposal:
setting out choices for the event or project and
enabling individual respondents to indicate
preferences amongst the choices and
a telecommunication address or number;
electronic advertisement of the event or project;
receiving preferences from respondents;
distributing to respondents the telecommunication address or number of other respondents and
determination of whether the received preferences are sufficient to warrant the event or project being triggered.

32. A facilitation method according to claim 31, wherein the telecommunication address or number of all previous respondents is distributed to all previous respondents.

33. A facilitation method according to claim 31, wherein the respondents are divided into groups and possibly sub-groups to be put in communication with each other.

34. A facilitation method according to claim 32, wherein the groups selected from the set consisting of:
time of response,
a predetermined number of respondents,
geographic location or age.

35. A facilitation method according to claim 31, wherein, with a view to a reward for promoting the project of event, respondents are provided with means for providing the communication details of other potential responders to whom the proposal can be advertised.

36. A facilitation method according to claim 36, wherein reward status is augmented by subsequent response by those to whom the event was advertised in this way.
